(19) United States
(12) Patent Application Publication
(10) Pub. No.: US 2026/0179624 A1
(43) Pub. Date: Jun. 25, 2026

(54) DSP MEMORY MANAGEMENT FOR AUDIO STREAM OFFLOADS

(71) Applicant: Advanced Micro Devices, Inc., Santa Clara, CA (US)

(72) Inventors: Ravikumar Badam, Hyderabad (IN); Nagabhushana Rao Modalavalasa, Hyderabad (IN)

(73) Assignee: Advanced Micro Devices, Inc., Santa Clara, CA (US)

(21) Appl. No.: 18/989,320

(22) Filed: Dec. 20, 2024

(51) Int. Cl. G10L 19/00

(52) U.S. Cl. CPC G10L 19/0017

(57) ABSTRACT

In order to conserve central processing unit (CPU) power during audio signal processing of ongoing audio streams, processing of the streams is offloaded to a digital signal processor (DSP) in some implementations. In some implementations, this offload includes storing data of the audio stream in DSP memory, where the DSP processes the audio stream data in the DSP memory. Different techniques for allocating DSP memory and/or storing audio stream data in the DSP memory have different advantages, such as power savings, in different implementations.

### BACKGROUND

Audio signal processing is typically performed to manipulate audio signals for reasons of storage, compression, speech processing and recognition, noise cancellation, equalization, filtering, and many other applications. Audio signal processing is typically performed by a processing device, such as a central processing unit (CPU), or other suitable processor.

In many applications, CPUs are put into a low power or sleep state in order to save power, however audio signal processing of ongoing audio streams may prevent a CPU from entering such states.

Digital signal processors (DSP) are specialized microprocessors for digital signal processing. A typical application for a DSP is audio signal processing, however DSPs are used for other purposes involving digital processing of signals (e.g., video, etc.).

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of example devices with which one or more features of the disclosure can be implemented;

FIG. 3 is a line graph illustrating example DSP memory utilization per-stream, according to an example implementation;

FIG. 4 is a bar graph illustrating example DSP memory allocation per-stream, according to the example implementation of FIG. 3;

FIG. 5 is a line graph illustrating example DSP memory utilization per-stream according to an example implementation;

FIG. 6 is a bar graph illustrating example DSP memory allocation per-stream, according to the example implementation of FIG. 5;

FIG. 7 is a bar graph illustrating example system bus access per-stream, according to the example implementation of FIG. 5 and FIG. 6;

FIG. 8 is a line graph illustrating example DSP memory utilization per-stream according to an example implementation;

FIG. 9 is a bar graph illustrating example DSP memory allocation per-stream, according to the example implementation of FIG. 8;

FIG. 10 is a bar graph illustrating example system bus access per-stream, according to the example implementation of FIG. 8 and FIG. 9; and

FIG. 11 is a flowchart illustrating an example method according to an example implementation.

### DETAILED DESCRIPTION

In order to conserve CPU power during audio signal processing of ongoing audio streams, processing of the streams is offloaded to a DSP in some implementations. In some implementations, this offload includes storing data of the audio stream in DSP memory, where the DSP processes the audio stream data in the DSP memory. Different techniques for allocating DSP memory and/or storing audio stream data in the DSP memory have different advantages, such as power savings, in different implementations.

Some implementations provide a method for processing audio streams by a DSP. A first portion of DSP memory is allocated to store data of a first audio stream. The data of the first audio stream is stored in the first portion. A size of the first portion of DSP memory is based on a number of streams offloaded to the DSP. In some implementations, a portion of the DSP memory is allocated to store data of audio streams offloaded from a host processor, and the first portion of DSP memory is allocated from the portion of the DSP memory allocated to store data of audio streams offloaded from the host processor. In some implementations, the size of the first portion of DSP memory is based on a maximum number of streams offloadable to the DSP. In some implementations, the size of the first portion of DSP memory is based on a maximum number of streams offloadable to the DSP from a host processor.

Some implementations include allocating a second portion of DSP memory to store data of a second audio stream; and reducing an amount of memory that is allocated to the first portion based on the number of streams offloaded to the DSP. Some implementations include allocating a second portion of DSP memory to store data of a second audio stream; and reducing an amount of memory that is allocated to the first portion based on a maximum number of streams offloadable to the DSP from a host processor. In some implementations, a size of the second portion is equal to the size of the first portion. In some implementations, a size of the second portion is based on a characteristic of the second audio stream, and the size of the first portion is based on a characteristic of the first audio stream. In some implementations, a size of the first portion gradually decreases based on the second portion. In some implementations, a portion of the DSP memory is allocated to store data of audio streams offloaded from a host processor, and a total size of DSP memory allocated to streams is less than a size of the portion of the DSP memory is allocated to store data of audio streams offloaded from the host processor.

Some implementations include a DSP. The DSP includes circuitry configured to allocate a first portion of DSP memory to store data of a first audio stream. The DSP includes circuitry configured to store the data of the first audio stream in the first portion. A size of the first portion of DSP memory is based on a number of streams offloaded to the DSP. In some implementations, a portion of the DSP memory is allocated to store data of audio streams offloaded from a host processor, and the first portion of DSP memory is allocated from the portion of the DSP memory allocated to store data of audio streams offloaded from the host processor. In some implementations, the size of the first portion of DSP memory is based on a maximum number of streams offloadable to the DSP. In some implementations, the size of the first portion of DSP memory is based on a maximum number of streams offloadable to the DSP from a host processor.

Some implementations include circuitry configured to allocate a second portion of DSP memory to store data of a second audio stream; and circuitry configured to reduce an amount of memory that is allocated to the first portion based on the number of streams offloaded to the DSP. Some implementations include circuitry configured to allocate a second portion of DSP memory to store data of a second audio stream; and circuitry configured to reduce an amount of memory that is allocated to the first portion based on a maximum number of streams offloadable to the DSP from a host processor. In some implementations, a size of the second portion is equal to the size of the first portion. In some implementations, a size of the second portion is based on a characteristic of the second audio stream, and the size of the first portion is based on a characteristic of the first audio stream. In some implementations, a size of the first portion gradually decreases based on the second portion. In some implementations, a portion of the DSP memory is allocated to store data of audio streams offloaded from a host processor, and a total size of DSP memory allocated to streams is less than a size of the portion of the DSP memory is allocated to store data of audio streams offloaded from the host processor.

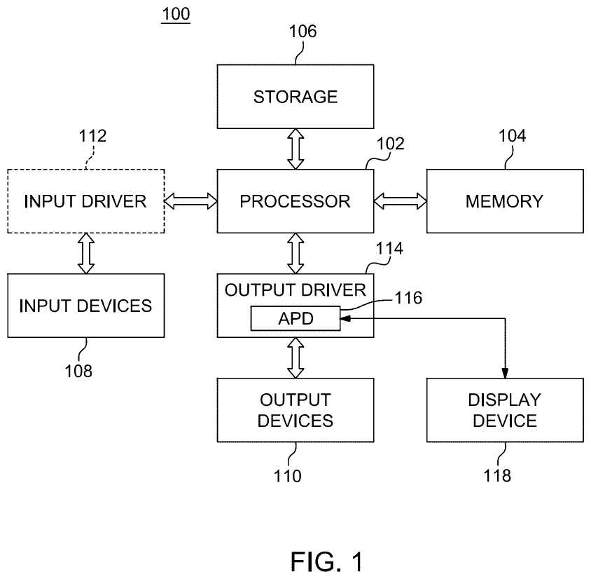

FIG. 1 is a block diagram of an example device 100 in which one or more features of the disclosure can be implemented. The device 100 can include, for example, a computer, a gaming device, a handheld device, a set-top box, a television, a mobile phone, server, a tablet computer or other types of computing devices. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid-state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display device 118, a display connector/interface (e.g., an HDMI or DisplayPort connector or interface for connecting to an HDMI or Display Port compliant device), a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 116 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm can also perform the functionality described herein.

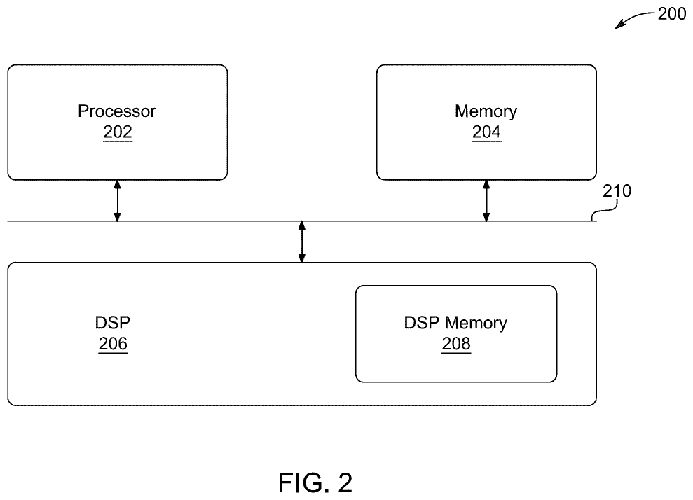

FIG. 2 is a block diagram of example devices 200 with which one or more features of the disclosure can be implemented. Example devices 200 include a processor 202, memory 204, and DSP 206, which includes a DSP memory 208. Processor 202, memory 204, and DSP 206 (including DSP memory 208) are in communication over a communication medium 210. In some implementations, example devices 200 are a part of example device 100 as shown and described with respect to FIG. 1.

Processor 202 includes any suitable processor, such as a CPU, that is capable of processing, and acting as a host for, audio streams (or in some implementations, other data such as video streams). For example, in some implementations, the processor is a host from the co-processor (e.g., DSP) perspective, where the processor provides operating system and user interaction functionality, and/or runs a device driver for the co-processor. In some implementations, processor 202 is capable of processing the audio streams, and/or is capable of offloading processing of the audio streams (or other data) to DSP 206. Example audio processing includes audio enhancement, noise suppression, compression, frame rate conversion (FC), sample rate conversion (SRC), and so forth. In some implementations, processor 202 performs audio processing on one or more audio streams, and outputs the one or more audio streams (e.g., to a speaker, such as via a speaker of output device 110 as shown and described with respect to FIG. 1 (e.g., via communication medium 210). Audio processing is exemplary, and other kinds of processing are usable in other implementations (e.g., video streams, etc.) In some implementations, processor 202 corresponds to processor 101 as shown and described with respect to FIG. 1.

Memory 204 includes any suitable memory circuitry which is capable of storing audio stream data (or other data, such as video stream data) for retrieval (e.g., via direct memory access (DMA)) and processing by processor 202 and/or DSP 206. In some implementations, memory 204 corresponds to memory 104 as shown and described with respect to FIG. 1.

DSP 206 includes any suitable digital signal processing circuitry configured to process an audio stream or other data (e.g., video stream). DSP 206 includes circuitry configured for taking over processing of an audio stream from processor 204. For example, in some implementations, DSP 206 receives a signal from processor 204 indicating that one or more streams are being offloaded to DSP 206. In some implementations, DSP 206 allocates a portion of DSP memory 208 for the stream, and transfers the audio stream, or a portion of the audio stream, from memory 204 to the allocated portion of DSP memory 208 for processing by DSP 206.

In some implementations, DSP 206 is capable of processing the audio streams, and/or is capable of receiving an offload of processing of the audio streams (or other data) from processor 204. Example audio processing includes audio enhancement, noise suppression, frame rate conversion (FC), sample rate conversion (SRC), and so forth. In some implementations, DSP 206 performs audio processing on one or more audio streams, and outputs the one or more audio streams (e.g., to a speaker, such as via a speaker of output device 110 as shown and described with respect to FIG. 1 (e.g., via communication medium 210). Audio processing is exemplary, and other kinds of processing are usable in other implementations (e.g., video streams, etc.).

DSP memory 208 includes any suitable memory circuitry for storing information to be processed by DSP 206 and/or information which was processed by DSP 206. For example, in some implementations, DSP memory 208 stores one or more audio streams for processing by DSP 206, or portions of one or more audio streams for processing by DSP 206.

Communication medium 210 includes any suitable medium for transferring information between any of processor 202, memory 204, and/or DSP 206 (including DSP memory 208). For example, in some implementations, communications medium 210 is or includes a data bus, such as a system bus, memory bus, internal data bus, peripheral component interconnect express (PCIe) bus, data fabric, or any other suitable bus or communications medium.

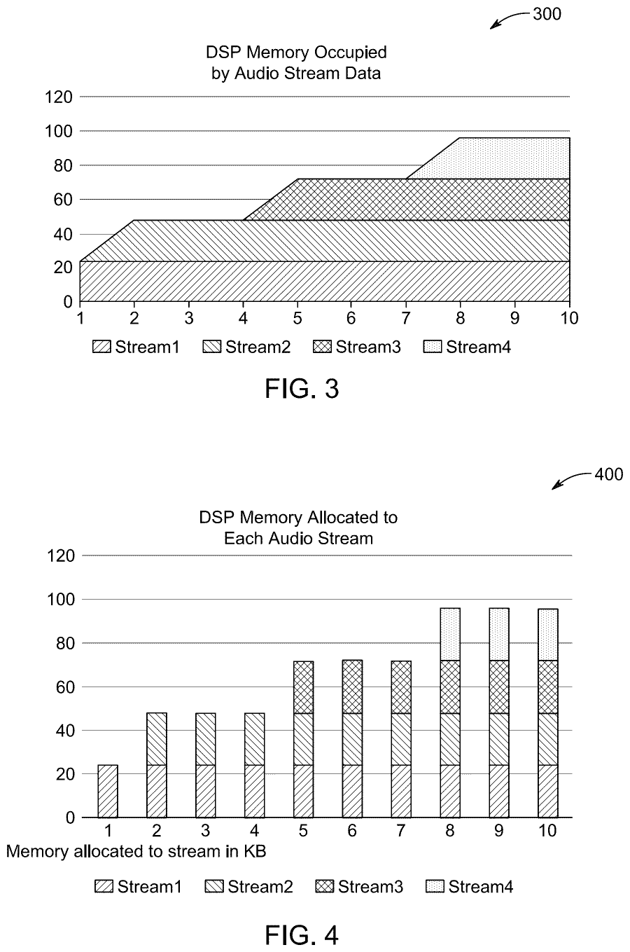

FIG. 3 is a line graph 300 illustrating example DSP memory utilization per-stream, according to an example implementation.

In this example, a DSP memory (such as DSP memory 208, as shown and described with respect to FIG. 2) is configured to support offloading of up to four audio streams from a processor (such as processor 202, as shown and described with respect to FIG. 2) by storing data of the audio streams. This number of streams is exemplary, and the DSP memory is configurable to store data for any desired number of streams in some implementations. Audio streams are an exemplary stream type, and other kinds of data streams are offloadable and stored in DSP memory in other implementations (e.g., video streams). In this example, 96 kilobytes of DSP memory is allocated for audio stream offloading, evenly distributed among all four possible audio streams.

At time 1, the processor has offloaded only one audio stream, Stream1, to the DSP, and accordingly, 24 kilobytes of Stream1 are stored in DSP memory. At time 1, the processor also begins to offload a second audio stream, Stream2, to the DSP. Accordingly, Stream2 data gradually fills an amount of DSP memory allocated for offload of a single audio stream until time 2, where 24 kilobytes of Stream 2 are stored in DSP memory, in addition to the 24 kilobytes of Stream1 that are already stored in DSP memory.

In some implementations, Stream2 data is transferred to the DSP memory from system memory (e.g., memory 104 as shown and described with respect to FIG. 1 and/or memory 204 as shown and described with respect to FIG. 2.) In some implementations, this transfer is via direct memory access (DMA). In some implementations, this transfer is managed by the DSP, without intervention by the processor (e.g., processor 102 as shown and described with respect to FIG. 1 and/or processor 202 as shown and described with respect to FIG. 2.) In some implementations, the processor enters a sleep or low power state after offloading the stream to the DSP. In some implementations, the DSP remains in the sleep or low power state while the audio stream data is transferred from memory to the DSP memory, and while the audio stream data is processed by the DSP.

During the time between time 2 and time 4, the processor sleeps or enters a low power state, and Stream1 and Stream2 are processed by the DSP, instead of the processor. In some implementations, this has the advantage of saving power by allowing the processor to remain in the sleep or low-power state.

At time 4, the processor wakes and begins to offload a third audio stream, Stream3, to the DSP. In some implementations, if the processor was in a sleep or low power state, the processor wakes in order to perform the offload. In some implementations, the processor enters or re-enters a sleep or low power state after performing (or beginning, or initiating) the offload. Accordingly, Stream3 data gradually fills an amount of DSP memory allocated for offload of a single audio stream until time 5, where 24 kilobytes of Stream 3 are stored in DSP memory, in addition to the 24 kilobytes of Stream1, and 24 kilobytes of Stream2 that are already stored in DSP memory.

During the time between time 5 and time 7, the processor sleeps or enters a low power state, and Stream1, Stream2, and Stream3 are processed by the DSP, instead of the processor. In some implementations, this has the advantage of saving power by allowing the processor to remain in the sleep or low-power state.

At time 7, the processor wakes and begins to offload a fourth audio stream, Stream4, to the DSP. In some implementations, if the processor was in a sleep or low power state, the processor wakes in order to perform the offload. In some implementations, the processor enters or re-enters a sleep or low power state after performing (or beginning, or initiating) the offload. Accordingly, Stream4 data gradually fills an amount of DSP memory allocated for offload of a single audio stream until time 8, where 24 kilobytes of Stream 4 are stored in DSP memory, in addition to the 24 kilobytes of Stream1, the 24 kilobytes of Stream2, and the 24 kilobytes of Stream3 that are already stored in DSP memory.

During the time after time 8, the processor sleeps or enters a low power state, and Stream1, Stream2, Stream3, and Stream4 are processed by the DSP, instead of the processor. In some implementations, this has the advantage of saving power by allowing the processor to remain in the sleep or low-power state.

It is noted that, in some cases, it is possible that any or all of Stream1, Stream2, Stream3, and/or Stream4 are greater than 24 kilobytes in size (or may be ongoing or otherwise indeterminate in size). Accordingly, in some implementations, after the DSP has completed processing of all of the data for a stream (24 kilobytes of data in this example), additional data of the stream is transferred to the DSP memory from system memory (e.g., from memory 104 as shown and described with respect to FIG. 1 and/or memory 204 as shown and described with respect to FIG. 2.) In some implementations, this transfer is via DMA. In some implementations, this transfer is managed by the processor (e.g., processor 102 as shown and described with respect to FIG. 1 and/or processor 202 as shown and described with respect to FIG. 2.) In some implementations, this transfer is managed by the DSP, without intervention by the processor (e.g., processor 102 as shown and described with respect to FIG. 1 and/or processor 202 as shown and described with respect to FIG. 2.) In some implementations, the stream data is identified to the DSP by the processor, and the identified stream data is transferred from main memory to the DSP memory by the DSP (e.g., via DMA).

FIG. 4 is a bar graph 400 illustrating example DSP memory allocation per-stream, according to the example implementation of FIG. 3. As shown in bar graph 400, a maximum of 24 kilobytes of DSP memory are allocated to each stream offloaded to the DSP, at each time, even in circumstances where fewer than the maximum number of audio streams (4 in this example) have been offloaded to the DSP. In other words, in such implementations, there is a maximum amount of DSP memory that is available for allocation to each offloaded stream, and this amount of DSP memory is less than the total amount of DSP memory that is available for allocation to all offloaded streams in implementations where the DSP supports offloading of more than one stream.

Table 1 lists the amount of DSP memory allocated, used, and unused, at each point in time:

TABLE 1

| | Time | Time | Time | Time | Time | Time | Time | Time | Time | Time |
|---|---|---|---|---|---|---|---|---|---|---|
| | 1 | 2 | 3 | 4 | 5 | 6 | 7 | 8 | 9 | 10 |
| Stream1 | 24 | 24 | 24 | 24 | 24 | 24 | 24 | 24 | 24 | 24 |
| Stream2 | 0 | 24 | 24 | 24 | 24 | 24 | 24 | 24 | 24 | 24 |
| Stream3 | 0 | 0 | 0 | 0 | 24 | 24 | 24 | 24 | 24 | 24 |
| Stream4 | 0 | 0 | 0 | 0 | 0 | 0 | 0 | 24 | 24 | 24 |
| TOTAL | 96 | 96 | 96 | 96 | 96 | 96 | 96 | 96 | 96 | 96 |
| ALLOCATED | | | | | | | | | | |
| DSP | | | | | | | | | | |
| MEMORY | | | | | | | | | | |
| TOTAL DSP | 24 | 48 | 48 | 48 | 72 | 72 | 72 | 96 | 96 | 96 |
| MEMORY | | | | | | | | | | |
| ALLOCATED | | | | | | | | | | |
| TO A | | | | | | | | | | |
| STREAM | | | | | | | | | | |
| TOTAL | 72 | 48 | 48 | 48 | 24 | 24 | 24 | 0 | 0 | 0 |
| ALLOCATED | | | | | | | | | | |
| DSP | | | | | | | | | | |
| MEMORY | | | | | | | | | | |
| NOT | | | | | | | | | | |
| ALLOCATED | | | | | | | | | | |
| TO A | | | | | | | | | | |
| STREAM | | | | | | | | | | |

As illustrated by FIGS. 2, 3, and Table 1, when four audio streams are offloaded to the DSP, each audio stream is allocated 24 kilobytes of DSP memory out of a total of 96 kilobytes of DSP memory allocated for audio stream offloads. Thus, all DSP memory allocated for audio stream offload is in use. This state exists only at times 8, 9, and 10, in this example. During other times (times 1-7), fewer than four audio streams are offloaded to the DSP. Accordingly, an amount of DSP memory allocated for audio stream offloads is unallocated at each of these times.

During operation, the DSP may process an audio stream stored in DSP memory until no further data of the audio stream has been processed. In some implementations, if processing of the audio stream is not complete (e.g., the DSP retrieves further information of the audio stream, and stores it in the DSP memory allocated for the audio stream. In some implementations, the DSP stores the new audio stream data in the DSP memory allocated for that stream by overwriting the audio stream data that was already processed from DSP memory. In some implementations, the DSP retrieves the further information of the audio stream from system memory (e.g., memory 104 as shown and described with respect to FIG. 1 and/or memory 204 as shown and described with respect to FIG. 2.)

In some implementations, the DSP waits until all of the audio stream data stored in DSP memory for a stream has been processed before retrieving further data for the stream. In some cases, this has the advantage of minimizing or reducing utilization of the communications medium (e.g., communication medium 210 as shown and described with respect to FIG. 2). In some implementations, this has the advantage of minimizing or reducing a number of times that it is necessary to wake the processor to initiate further transfer of data. In some implementations, the DSP does not wait until all of the audio stream data stored in DSP memory for a stream has been processed before retrieving further data for the stream. In some cases, this has the advantage of minimizing or reducing interruption of the processing of the audio stream (e.g., due to latency in communication medium 210 as shown and described with respect to FIG. 2).

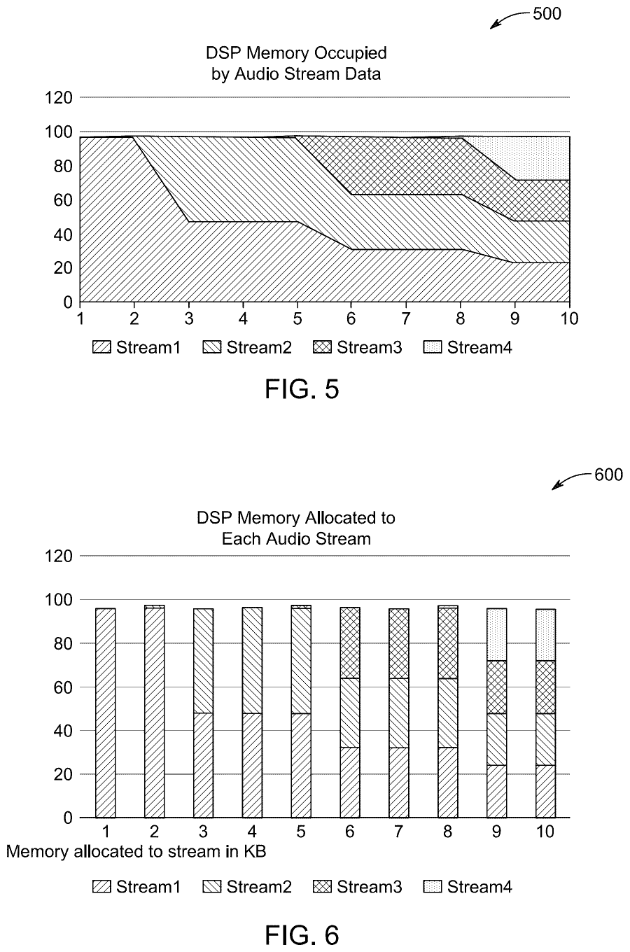

FIG. 5 is a line graph 500 illustrating example DSP memory utilization per-stream according to an example implementation.

In this example, a DSP memory (such as DSP memory 208, as shown and described with respect to FIG. 2) is configured to support offloading of up to four audio streams from a processor (such as processor 202, as shown and described with respect to FIG. 2). This number of streams is exemplary; the DSP memory is configurable to offload any desired number of streams in some implementations. Audio streams are, exemplary, and other kinds of data are usable in other implementations (e.g., video streams). In this example, 96 kilobytes of DSP memory is allocated for audio stream offloading. Unlike the example of FIG. 3, FIG. 4, and Table 1, the total DSP memory allocation for stream offloading (i.e., the 96 kilobytes in this example) is not evenly distributed among all four possible audio streams. In this example, in some implementations, the size of the DSP memory allocation for each stream depends on the total number of streams that are currently offloaded to the DSP.

At time 1, the processor has offloaded only one audio stream, Stream1, to the DSP. No other streams have been offloaded to the DSP at time 1. Accordingly, all 96 kilobytes of the total DSP memory allocation for stream offloading are allocated to Stream1, and 96 kilobytes of Stream1 are stored in DSP memory.

The processor also initiates offloading of a second audio stream, Stream2, to the DSP at time 1. Since all 96 kilobytes of the total DSP memory allocation are currently occupied by Stream1, the amount of total DSP memory allocation for stream offloading is first rebalanced before Stream2 data is written to DSP memory. Since two streams are now being offloaded to the DSP, the total DSP memory allocation (i.e., 96 kilobytes) is divided evenly between the two streams. Accordingly, each are allocated 48 kilobytes of DSP memory.

It is noted that at time 1, even though two streams are now being offloaded to the DSP, 96 kilobytes of unprocessed Stream1 data are still resident in the DSP memory. Accordingly, the Stream2 data is not transferred to the DSP memory until enough of the 96 kilobytes of the total DSP memory allocation currently occupied by Stream1 has emptied (i.e., has been processed by the DSP) to the point where only 48 kilobytes of unprocessed Stream1 data remains in the DSP memory.

In some implementations, while the Stream1 data empties, a small amount of DSP memory is allocated as a buffer (e.g., a ping-pong buffer) to hold one frame at a time of Stream2 while the Stream1 data empties. In other words, the processor remains awake and continually transfers one frame at a time of the Stream2 data. In some implementations, the small amount of DSP memory is allocated from memory outside of the total amount of DSP memory allocated for stream offloading (i.e., outside of the 96 kilobytes in this example

At time 2, enough of Stream1 has been processed by the DSP for 48 kilobytes of Stream2 to be transferred to DSP memory. Accordingly, Stream2 data gradually fills an amount of DSP memory allocated for offload of a Stream2 until time 3, where 48 kilobytes of Stream2 are stored in DSP memory, in addition to the 48 kilobytes of Stream1 that remain in DSP memory.

In some implementations, Stream2 data is transferred to the DSP memory from system memory (e.g., memory 104 as shown and described with respect to FIG. 1 and/or memory 204 as shown and described with respect to FIG. 2.) In some implementations, this transfer is via direct memory access (DMA). In some implementations, this transfer is managed by the DSP, without intervention by the processor (e.g., processor 102 as shown and described with respect to FIG. 1 and/or processor 202 as shown and described with respect to FIG. 2.) In some implementations, the processor enters a sleep or low power state after offloading the stream to the DSP. In some implementations, the DSP remains in the sleep or low power state while the audio stream data is transferred from memory to the DSP memory, and while the audio stream data is processed by the DSP.

During the time between time 3 and time 4, the processor sleeps or enters a low power state, and Stream1 and Stream2 are processed by the DSP, instead of the processor. In some implementations, this has the advantage of saving power by allowing the processor to remain in the sleep or low-power state.

At time 4, the processor begins to offload a third audio stream, Stream3, to the DSP. Since all 96 kilobytes of the total DSP memory allocation are currently occupied by Stream1 and Stream2, the amount of total DSP memory allocation for stream offloading is first rebalanced before Stream3 data is written to DSP memory. Since three streams are now being offloaded to the DSP, the total DSP memory allocation (i.e., 96 kilobytes) is divided evenly between the three streams. Accordingly, each are allocated 32 kilobytes of DSP memory.

It is noted that at time 4, even though three streams are now being offloaded to the DSP, 96 kilobytes of unprocessed Stream1 and Stream2 data are still resident in the DSP memory. Accordingly, the Stream3 data is not transferred to the DSP memory until enough of the 96 kilobytes of the total DSP memory allocation currently occupied by Stream1 and Stream2 has emptied (i.e., has been processed by the DSP) to the point where only 32 kilobytes of unprocessed Stream1 data and 32 kilobytes of unprocessed Stream2 data remains in the DSP memory.

In some implementations, a small amount of the total DSP memory allocation is allocated as a buffer (e.g., a ping-pong buffer) to hold one frame at a time of Stream3 while the Stream1 and Stream2 data empties. In other words, the processor remains awake and continually transfers one frame at a time of the Stream3 data.

At time 5, enough of Stream1 and Stream2 have been processed by the DSP for 32 kilobytes of Stream4 to be transferred to DSP memory. Accordingly, Stream3 data gradually fills an amount of DSP memory allocated for offload of Stream3 until time 6, where 32 kilobytes of Stream3 are stored in DSP memory, in addition to the 32 kilobytes of Stream1 and 32 kilobytes of Stream2 that remain in DSP memory.

In some implementations, if the processor was in a sleep or low power state, the processor wakes in order to perform the offload. In some implementations, the processor enters or re-enters a sleep or low power state after performing (or beginning, or initiating) the offload.

During the time between time 6 and time 7, the processor sleeps or enters a low power state, and Stream1, Stream2, and Stream3 are processed by the DSP, instead of the processor. In some implementations, this has the advantage of saving power by allowing the processor to remain in the sleep or low-power state

At time 7, the processor begins to offload a fourth audio stream, Stream4, to the DSP. Since all 96 kilobytes of the total DSP memory allocation are currently occupied by Stream1, Stream2, and Stream3, the amount of total DSP memory allocation for stream offloading is first rebalanced before Stream4 data is written to DSP memory. Since four streams are now being offloaded to the DSP, the total DSP memory allocation (i.e., 96 kilobytes) is divided evenly between the four streams. Accordingly, each are allocated 24 kilobytes of DSP memory.

It is noted that at time 7, even though four streams are now being offloaded to the DSP, 96 kilobytes of unprocessed Stream1, Stream2, and Stream3 data are still resident in the DSP memory. Accordingly, the Stream4 data is not transferred to the DSP memory until enough of the 96 kilobytes of the total DSP memory allocation currently occupied by Stream1, Stream2, and Stream3 has emptied (i.e., has been processed by the DSP) to the point where only 24 kilobytes of unprocessed Stream1, 32 kilobytes of unprocessed Stream2 data, and 32 Kilobytes of unprocessed Stream3 data remains in the DSP memory.

In some implementations, a small amount of the total DSP memory allocation is allocated as a buffer (e.g., a ping-pong buffer) to hold one frame at a time of Stream4 while the Stream1, Stream2, and Stream3 data empties. In other words, the processor remains awake and continually transfers one frame at a time of the Stream4 data.

At time 8, enough of Stream1, Stream2, and Stream3 have been processed by the DSP for 24 kilobytes of Stream4 to be transferred to DSP memory. Accordingly, Stream4 data gradually fills an amount of DSP memory allocated for offload of Stream4 until time 9, where 24 kilobytes of Stream4 are stored in DSP memory, in addition to the 24 kilobytes of Stream1, 24 kilobytes of Stream2, and 24 kilobytes of Stream3 that remain in DSP memory.

In some implementations, if the processor was in a sleep or low power state, the processor wakes in order to perform the offload. In some implementations, the processor enters or re-enters a sleep or low power state after performing (or beginning, or initiating) the offload.

During the time after time 9, the processor sleeps or enters a low power state, and Stream1, Stream2, Stream3, and Stream4 are processed by the DSP, instead of the processor. In some implementations, this has the advantage of saving power by allowing the processor to remain in the sleep or low-power state.

It is noted that, in some cases, it is possible that any or all of Stream1, Stream2, Stream3, and/or Stream4 are greater than 24 kilobytes in size (or may be ongoing or otherwise indeterminate in size). Accordingly, in some implementations, after the DSP has completed processing of all of the data for a stream (24 kilobytes of data in this example), additional data of the stream is transferred to the DSP memory from system memory (e.g., from memory 104 as shown and described with respect to FIG. 1 and/or memory 204 as shown and described with respect to FIG. 2.) In some implementations, this transfer is via DMA. In some implementations, this transfer is managed by the DSP, without intervention by the processor (e.g., processor 102 as shown and described with respect to FIG. 1 and/or processor 202 as shown and described with respect to FIG. 2.) In some implementations, the processor (e.g., a device driver of the processor) provides a region of memory (e.g., memory 204) as a buffer for stream data. In some implementations, the DSP transfers the stream data from this buffer via the bus 210 (e.g., via DMA) without waking the processor as long as there is data in the buffer.

FIG. 6 is a bar graph 600 illustrating example DSP memory allocation per-stream, according to the example implementation of FIG. 5.

As shown in bar graph 600, the total amount of DSP memory allocated for all stream offloading is allocated amongst the actual number of audio streams currently offloaded to the DSP. In this example, the total amount of DSP memory allocated for all stream offloading is allocated evenly amongst the actual number of audio streams currently offloaded to the DSP, however, in some implementations, the total amount of DSP memory allocated for all stream offloading is unevenly allocated amongst the actual number of audio streams currently offloaded to the DSP (e.g., based on characteristics of the stream, such as sampling rate, bit depth, number of channels, etc., or any other suitable basis).

In this example, at time 1, 96 kilobytes of the DSP memory allocated for all stream offloading is allocated to Stream1, since only one stream has been offloaded.

At time 1, 96 kilobytes of the DSP memory allocated for all stream offloading is allocated to Stream1, since only one stream has been offloaded. At time 2, an additional amount of DSP memory is allocated as a buffer (e.g., ping-pong buffer) for Stream2 while Stream1 data empties from the DSP memory allocated for all stream offloading. For the sake of example, the additional amount of DSP memory allocated as a buffer for Stream2 while Stream1 data empties from the DSP memory allocated for all stream offloading is 1 kilobyte. At time 3, 48 kilobytes of the DSP memory allocated for all stream offloading is allocated to Stream1, and 48 kilobytes of the DSP memory allocated for all stream offloading is allocated to Stream2, since two streams have been offloaded (i.e., half for each).

At time 5, an additional amount of DSP memory (1 kilobyte for example) is allocated as a buffer (e.g., ping-pong buffer) for Stream3 while Stream1 and Stream2 data empties from the DSP memory allocated for all stream offloading. At time 6, 32 kilobytes of the DSP memory allocated for all stream offloading is allocated to Stream1, 32 kilobytes of the DSP memory allocated for all stream offloading is allocated to Stream2, and 32 kilobytes of the DSP memory allocated for all stream offloading is allocated to Stream3, since three streams have been offloaded. At time 8, an additional amount of DSP memory (1 kilobyte for example) is allocated as a buffer (e.g., ping-pong buffer) for Stream4 while Stream1, Stream2, and Stream3 data empties from the DSP memory allocated for all stream offloading.

At time 9, 24 kilobytes of the DSP memory allocated for all stream offloading is allocated to Stream1, 24 kilobytes of the DSP memory allocated for all stream offloading is allocated to Stream2, 24 kilobytes of the DSP memory allocated for all stream offloading is allocated to Stream3, and 24 kilobytes of the DSP memory allocated for all stream offloading is allocated to Stream4, since four streams have been offloaded.

Here, the maximum amount of DSP memory allocated to each stream offloaded to the DSP varies based on the number of audio streams that have been offloaded to the DSP. In other words, in such implementations, all of the DSP memory allocated for offloading of data streams is allocated to offloaded streams, regardless of the number of streams that have been offloaded to the DSP (as long as one stream has been offloaded). In some implementations, this has the advantage of increasing the amount of time that the processor can remain asleep before it needs to refill data in the DSP memory for a stream in cases where fewer than the maximum number of streams has been offloaded to the DSP (where the DSP supports offloading of more than one stream).

Table 2 lists the amount of DSP memory allocated, used, and unused, at each point in time:

TABLE 2

| | Time | Time | Time | Time | Time | Time | Time | Time | Time | Time |
|---|---|---|---|---|---|---|---|---|---|---|
| | 1 | 2 | 3 | 4 | 5 | 6 | 7 | 8 | 9 | 10 |
| Stream1 | 96 | 96 | 48 | 48 | 48 | 32 | 32 | 32 | 24 | 24 |
| Stream2 | 0 | 1 | 48 | 48 | 48 | 32 | 32 | 32 | 24 | 24 |
| Stream3 | 0 | 0 | 0 | 0 | 1 | 32 | 32 | 32 | 24 | 24 |
| Stream4 | 0 | 0 | 0 | 0 | 0 | 0 | 0 | 1 | 24 | 24 |
| TOTAL | 96 | 96 | 96 | 96 | 96 | 96 | 96 | 96 | 96 | 96 |
| ALLOCATED | | | | | | | | | | |
| DSP | | | | | | | | | | |
| MEMORY | | | | | | | | | | |
| TOTAL DSP | 96 | 96 | 96 | 96 | 96 | 96 | 96 | 96 | 96 | 96 |
| MEMORY | | | | | | | | | | |
| ALLOCATED | | | | | | | | | | |
| TO A | | | | | | | | | | |
| STREAM | | | | | | | | | | |
| TOTAL | 0 | 0 | 0 | 0 | 0 | 0 | 0 | 0 | 0 | 0 |
| ALLOCATED | | | | | | | | | | |
| DSP | | | | | | | | | | |
| MEMORY | | | | | | | | | | |
| NOT | | | | | | | | | | |
| ALLOCATED | | | | | | | | | | |
| TO A | | | | | | | | | | |
| STREAM | | | | | | | | | | |

As illustrated by FIGS. 4, 5, and Table 2, when any number of audio streams are offloaded to the DSP, each audio stream is allocated an even share of all of the total of 96 kilobytes of DSP memory allocated for audio stream offloads. Thus, all DSP memory allocated for audio stream offload is allocated to a stream, no matter how many streams have been offloaded. Accordingly, no amount of DSP memory allocated for audio stream offloads remains unallocated to a stream at any time (assuming at least one stream has been offloaded to the DSP).

During operation, the DSP may process an audio stream stored in DSP memory until no further data of the audio stream has been processed. In some implementations, if processing of the audio stream is not complete (e.g., the DSP retrieves further information of the audio stream, and stores it in the DSP memory allocated for the audio stream. In some implementations, the DSP stores the new audio stream data in the DSP memory allocated for that stream by overwriting the audio stream data that was already processed from DSP memory. In some implementations, the DSP retrieves the further information of the audio stream from system memory (e.g., memory 104 as shown and described with respect to FIG. 1 and/or memory 204 as shown and described with respect to FIG. 2.) In some implementations, the DSP retrieves the further information from system memory via DMA.

In some implementations, the DSP waits until all of the audio stream data stored in DSP memory for a stream has been processed before retrieving further data for the stream. In some cases, this has the advantage of minimizing or reducing utilization of the communications medium (e.g., communication medium 210 as shown and described with respect to FIG. 2). In some implementations, this has the advantage of minimizing or reducing a number of times that it is necessary to wake the processor to initiate further transfer of data (and potentially saving power). In some implementations, the DSP does not wait until all of the audio stream data stored in DSP memory for a stream has been processed before retrieving further data for the stream. In some cases, this has the advantage of minimizing or reducing interruption of the processing of the audio stream (e.g., due to latency in communication medium 210 as shown and described with respect to FIG. 2).

In the example of FIG. 5, FIG. 6, and Table 2, the potential power saving is greater than in the example of FIG. 3, FIG. 4, and Table 2, since all of the DSP memory allocated for stream offloading is allocated to a stream at any given time (as long as at least one stream has been offloaded), allowing a longer time between processor wakeups to refill the DSP buffer in some cases.

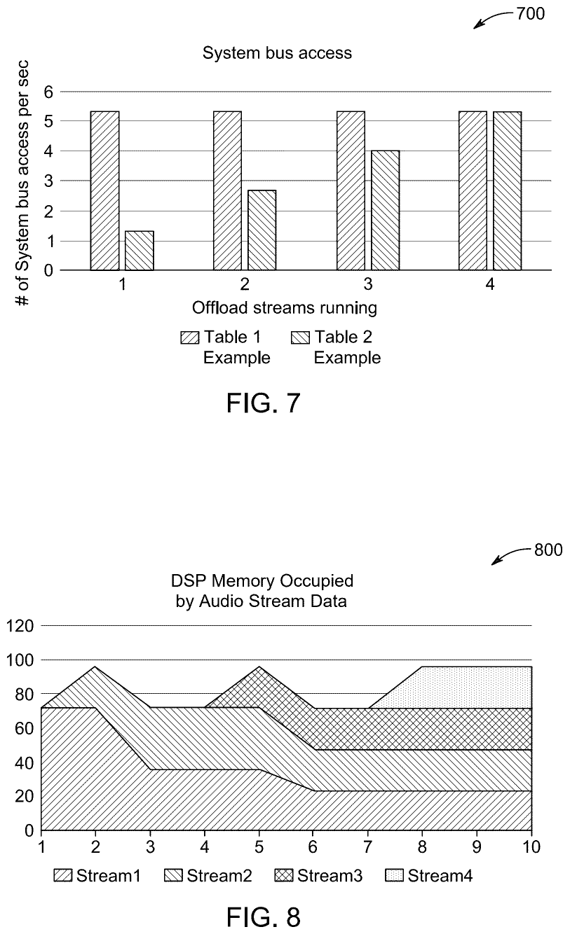

FIG. 7 is a bar graph 700 illustrating a comparison of example system bus access per offloaded stream according to the example implementation of FIG. 3, FIG. 4, and Table 1 versus the example implementation of FIG. 5, FIG. 6, and Table 2, and Table 3 lists the amount of DSP memory allocated, used, and unused, at each point in time:

TABLE 3

| | For 1 | For 2 | For 3 | For 4 |
|---|---|---|---|---|
| | Stream | Stream | Stream | Stream |
| | Offload | Offloads | Offloads | Offloads |
| Number of | 5 | 5 | 5 | 5 |
| System Bus | | | | |
| Accesses Per | | | | |
| Second using | | | | |
| the Table 1 | | | | |
| Approach | | | | |
| Number of | 1 | 3 | 4 | 5 |
| System Bus | | | | |
| Accesses Per | | | | |
| Second using | | | | |
| the Table 2 | | | | |
| Approach | | | | |

As can be seen from the graph and Table 3, system bus accesses are less frequent using the example implementation of FIG. 5, FIG. 6, and Table 2 for cases where fewer than the maximum number of stream offloads have been offloaded to the DSP. This is because each offloaded stream is allocated a larger amount of DSP memory for its offload.

FIG. 8 is a line graph 800 illustrating example DSP memory utilization per-stream according to an example implementation.

In this example, a DSP memory (such as DSP memory 208, as shown and described with respect to FIG. 2) is configured to support offloading of up to four audio streams from a processor (such as processor 202, as shown and described with respect to FIG. 2). This number of streams is exemplary; the DSP memory is configurable to offload any desired number of streams in some implementations. Audio streams are, exemplary, and other kinds of data are usable in other implementations (e.g., video streams).

In this example, 96 kilobytes of DSP memory is allocated for audio stream offloading. The total DSP memory allocation for stream offloading (i.e., the 96 kilobytes in this example) is not evenly distributed among all four possible audio streams, but depends on the total number of streams that are currently offloaded to the DSP. However, the total DSP memory allocation for stream offloading is also not entirely allocated to streams in cases where fewer than the maximum number of streams (4 in this case) are offloaded to the DSP. Rather, a portion (one fourth, or 24 kilobytes in this example) of the DSP memory allocated for audio stream offloading is maintained as unallocated so that it may be immediately allocated to a new stream offload, if a new stream is offloaded to the DSP.

At time 1, the processor has offloaded only one audio stream, Stream1, to the DSP. No other streams have been offloaded to the DSP at time 1. Accordingly, 72 kilobytes of the total DSP memory allocation for stream offloading are allocated to Stream1, and 72 kilobytes of Stream1 are stored in DSP memory. 24 kilobytes of the total DSP memory allocation for stream offloading remains unallocated to a stream, unallocated so that it may be immediately allocated to a new stream offload, if a new stream is offloaded to the DSP.

The processor also initiates offloading of a second audio stream, Stream2, to the DSP at time 1. Since all 72 kilobytes of the total DSP memory allocation (i.e., 96 kilobytes less the 24 kilobyte reserve) are currently occupied by Stream1, the amount of total DSP memory allocation for stream offloading, less the reserve, is rebalanced. Since two streams are now being offloaded to the DSP, the total DSP memory allocation, less the reserve (i.e., 72 kilobytes) is divided evenly between the two streams. Accordingly, each are allocated 36 kilobytes of DSP memory.

Since 24 kilobytes of the total DSP memory allocation for stream offloading have been reserved for allocation to a newly allocated stream, Stream2 data immediately begins to gradually fill an amount of DSP memory allocated for offload of a Stream2, until the reserve 24 kilobytes have been filled with Stream2 data at time 2.

At time 2, Stream1 data begins to empty from the DSP memory allocated for offload while Stream2 data continues to fill the DSP memory allocated for offload until 32 kilobytes of the DSP memory allocated for offload are allocated to Stream1, 32 kilobytes of the DSP memory allocated for offload are allocated to Stream2, and 24 kilobytes of the DSP memory allocated for offload become unallocated, so that they may be immediately allocated to a new stream offload, if a new stream is offloaded to the DSP.

In some implementations, Stream2 data is transferred to the DSP memory from system memory (e.g., memory 104 as shown and described with respect to FIG. 1 and/or memory 204 as shown and described with respect to FIG. 2.) In some implementations, this transfer is via direct memory access (DMA). In some implementations, this transfer is managed by the DSP, without intervention by the processor (e.g., processor 102 as shown and described with respect to FIG. 1 and/or processor 202 as shown and described with respect to FIG. 2.) In some implementations, the processor enters a sleep or low power state after offloading the stream to the DSP. In some implementations, the DSP remains in the sleep or low power state while the audio stream data is transferred from memory to the DSP memory, and while the audio stream data is processed by the DSP.

During the time between time 3 and time 4, the processor sleeps or enters a low power state, and Stream1 and Stream2 are processed by the DSP, instead of the processor. In some implementations, this has the advantage of saving power by allowing the processor to remain in the sleep or low-power state. A portion (24 kilobytes in this example) of the DSP memory allocated for audio stream offloading is maintained as unallocated so that it may be immediately allocated to a new stream offload, if a new stream is offloaded to the DSP.

At time 4, the processor begins to offload a third audio stream, Stream3, to the DSP. Since all 72 kilobytes of the total DSP memory allocation (i.e., 96 kilobytes less the 24 kilobyte reserve) are currently occupied by Stream1 and Stream2, the amount of total DSP memory allocation for stream offloading, less the reserve, is rebalanced. Since three streams are now being offloaded to the DSP, the total DSP memory allocation, less the reserve (i.e., 72 kilobytes) is divided evenly between the three streams. Accordingly, each are allocated 24 kilobytes of DSP memory.

Since 24 kilobytes of the total DSP memory allocation for stream offloading have been reserved for allocation to a newly allocated stream, Stream2 data immediately begins to gradually fill an amount of DSP memory allocated for offload of a Stream2, until the reserve 24 kilobytes have been filled with Stream2 data at time 4.

At time 5, Stream1 data and Stream2 data begin to empty from the DSP memory allocated for offload while Stream3 data continues to fill the DSP memory allocated for offload until 24 kilobytes of the DSP memory allocated for offload are allocated to Stream1, 24 kilobytes of the DSP memory allocated for offload are allocated to Stream2, 24 kilobytes of the DSP memory allocated for offload are allocated to Stream3, and 24 kilobytes of the DSP memory allocated for offload become unallocated, so that they may be immediately allocated to a new stream offload, if a new stream is offloaded to the DSP.

In some implementations, Stream3 data is transferred to the DSP memory from system memory (e.g., memory 104 as shown and described with respect to FIG. 1 and/or memory 204 as shown and described with respect to FIG. 2.) In some implementations, this transfer is via direct memory access (DMA). In some implementations, this transfer is managed by the DSP, without intervention by the processor (e.g., processor 102 as shown and described with respect to FIG. 1 and/or processor 202 as shown and described with respect to FIG. 2.) In some implementations, the processor enters a sleep or low power state after offloading the stream to the DSP. In some implementations, the DSP remains in the sleep or low power state while the audio stream data is transferred from memory to the DSP memory, and while the audio stream data is processed by the DSP.

During the time between time 6 and time 7, the processor sleeps or enters a low power state, and Stream1, Stream2, and Stream3 are processed by the DSP, instead of the processor. In some implementations, this has the advantage of saving power by allowing the processor to remain in the sleep or low-power state. A portion (24 kilobytes in this example) of the DSP memory allocated for audio stream offloading is maintained as unallocated so that it may be immediately allocated to a new stream offload, if a new stream is offloaded to the DSP.

At time 7, Since all 72 kilobytes of the total DSP memory allocation (i.e., 96 kilobytes less the 24 kilobyte reserve) are currently occupied by Stream1, Stream2, and Stream3, the DSP memory allocation for stream offloading is rebalanced. Since four streams are now being offloaded to the DSP, the total DSP memory allocation is divided evenly between the four streams. Further, since the maximum number of streams is being offloaded, no DSP memory allocated for stream offloading is held in reserve. Accordingly, each of Stream1, Stream2, Stream3, and Stream4 are allocated 24 kilobytes of DSP memory.

Since 24 kilobytes of the total DSP memory allocation for stream offloading had been reserved for allocation to a newly allocated stream, Stream4 data immediately begins to gradually fill an amount of DSP memory allocated for offload of Stream4, until the reserve 24 kilobytes have been filled with Stream4 data at time 8.

Since none of the total DSP memory allocation for stream offloading is now being held in reserve, the Stream1, Stream2, and Stream3 data do not need to empty. Accordingly, at time 8, 24 kilobytes of the DSP memory allocated for offload are allocated to Stream1, 24 kilobytes of the DSP memory allocated for offload are allocated to Stream2, 24 kilobytes of the DSP memory allocated for offload are allocated to Stream3, and 24 kilobytes of the DSP memory allocated to Stream4.

In some implementations, Stream4 data is transferred to the DSP memory from system memory (e.g., memory 104 as shown and described with respect to FIG. 1 and/or memory 204 as shown and described with respect to FIG. 2.) In some implementations, this transfer is via direct memory access (DMA). In some implementations, this transfer is managed by the DSP, without intervention by the processor (e.g., processor 102 as shown and described with respect to FIG. 1 and/or processor 202 as shown and described with respect to FIG. 2.) In some implementations, the processor enters a sleep or low power state after offloading the stream to the DSP. In some implementations, the DSP remains in the sleep or low power state while the audio stream data is transferred from memory to the DSP memory, and while the audio stream data is processed by the DSP.

During the time between time 8 and time 10, the processor sleeps or enters a low power state, and Stream1, Stream2, Stream3, and Stream4 are processed by the DSP, instead of the processor. In some implementations, this has the advantage of saving power by allowing the processor to remain in the sleep or low-power state.

In some implementations, if the processor was in a sleep or low power state, the processor wakes in order to perform the offload. In some implementations, the processor enters or re-enters a sleep or low power state after performing (or beginning, or initiating) the offload.

FIG. 9 is a bar graph 900 illustrating example DSP memory allocation per-stream, according to the example implementation of FIG. 8.

As shown in bar graph 900, the total amount of DSP memory allocated for all stream offloading, less a reserve, is allocated amongst the actual number of audio streams currently offloaded to the DSP (except when the reserve is being filled by a newly offloaded stream). In this example, the total amount of DSP memory allocated for all stream offloading (less the reserve, where applicable) is allocated evenly amongst the actual number of audio streams currently offloaded to the DSP, however, in some implementations, the total amount of DSP memory allocated for all stream offloading (less the reserve, where applicable) is unevenly allocated amongst the actual number of audio streams currently offloaded to the DSP (e.g., based on characteristics of the stream, or any other suitable basis).

In this example, at time 1, 72 kilobytes of the DSP memory allocated for all stream offloading is allocated to Stream1, and 24 kilobytes of the DSP memory allocated for all stream offloading are held in reserve (i.e., are not allocated to a stream) since only one stream (i.e., fewer than the maximum number of streams) has been offloaded.

At time 2, the reserve 24 kilobytes have been filled with Stream2 data, and the Stream1 data begins to empty while Stream2 data continues filling the DSP memory.

At time 3, 36 kilobytes of the DSP memory allocated for all stream offloading is allocated to Stream1, 36 kilobytes of the DSP memory allocated for all stream offloading is allocated to Stream2, and 24 kilobytes of the DSP memory allocated for all stream offloading are held in reserve (i.e., are not allocated to a stream) since only two streams (i.e., fewer than the maximum number of streams) have been offloaded.

At time 5, the reserve 24 kilobytes have been filled with Stream3 data, and the Stream1 and Stream2 data begin to empty while Stream3 data continues filling the DSP memory.

At time 6, 24 kilobytes of the DSP memory allocated for all stream offloading is allocated to Stream1, 24 kilobytes of the DSP memory allocated for all stream offloading is allocated to Stream2, 24 kilobytes of the DSP memory allocated for all stream offloading is allocated to Stream3, and 24 kilobytes of the DSP memory allocated for all stream offloading are held in reserve (i.e., are not allocated to a stream) since only three streams (i.e., fewer than the maximum number of streams) have been offloaded.

At time 8, the reserve 24 kilobytes have been filled with Stream4 data. 24 kilobytes of the DSP memory allocated for all stream offloading is allocated to Stream1, 24 kilobytes of the DSP memory allocated for all stream offloading is allocated to Stream2, 24 kilobytes of the DSP memory allocated for all stream offloading is allocated to Stream3, and 24 kilobytes of the DSP memory allocated for all stream offloading is allocated to Stream4. None of the DSP memory allocated for all stream offloading is held in reserve since four streams (i.e., the maximum number of streams) have been offloaded.

Here, the maximum amount of DSP memory allocated to each stream offloaded to the DSP varies based on the number of audio streams that have been offloaded to the DSP. In other words, in such implementations, all of the DSP memory allocated for offloading of data streams (that is not being held in reserve, where applicable) is allocated to offloaded streams, regardless of the number of streams that have been offloaded to the DSP (as long as one stream has been offloaded). In some implementations, this has the advantage of increasing the amount of time that the processor can remain asleep before it needs to refill data in the DSP memory for a stream in cases where fewer than the maximum number of streams has been offloaded to the DSP (where the DSP supports offloading of more than one stream).

Table 4 lists the amount of DSP memory allocated, used, and unused, at each point in time:

TABLE 4

| | Time | Time | Time | Time | Time | Time | Time | Time | Time | Time |
|---|---|---|---|---|---|---|---|---|---|---|
| | 1 | 2 | 3 | 4 | 5 | 6 | 7 | 8 | 9 | 10 |
| Stream1 | 72 | 72 | 36 | 36 | 36 | 24 | 24 | 24 | 24 | 24 |
| Stream2 | 0 | 24 | 36 | 36 | 36 | 24 | 24 | 24 | 24 | 24 |
| Stream3 | 0 | 0 | 0 | 0 | 24 | 24 | 24 | 24 | 24 | 24 |
| Stream4 | 0 | 0 | 0 | 0 | 0 | 0 | 0 | 24 | 24 | 24 |
| Reserve | 24 | 0 | 24 | 24 | 0 | 24 | 24 | 0 | 0 | 0 |
| TOTAL | 96 | 96 | 96 | 96 | 96 | 96 | 96 | 96 | 96 | 96 |
| ALLOCATED | | | | | | | | | | |
| DSP | | | | | | | | | | |
| MEMORY | | | | | | | | | | |
| TOTAL DSP | 72 | 96 | 72 | 72 | 96 | 72 | 72 | 96 | 96 | 96 |
| MEMORY | | | | | | | | | | |
| ALLOCATED | | | | | | | | | | |
| TO A | | | | | | | | | | |
| STREAM | | | | | | | | | | |
| TOTAL | 24 | 0 | 24 | 24 | 0 | 24 | 24 | 0 | 0 | 0 |
| ALLOCATED | | | | | | | | | | |
| DSP | | | | | | | | | | |
| MEMORY | | | | | | | | | | |
| NOT | | | | | | | | | | |
| ALLOCATED | | | | | | | | | | |
| TO A | | | | | | | | | | |
| STREAM | | | | | | | | | | |

As illustrated by FIGS. 8, 9, and Table 4, when any number of audio streams are offloaded to the DSP, each audio stream is allocated an even share of all of the total of 96 kilobytes of DSP memory allocated for audio stream offloads, less a 24 kilobyte reserve where applicable. Thus, all DSP memory allocated for audio stream offload, less a 24 kilobyte reserve where applicable, is allocated to a stream, no matter how many streams have been offloaded. Accordingly, no amount of DSP memory allocated for audio stream offloads, less a 24 kilobyte reserve where applicable, remains unallocated to a stream at any time (assuming at least one stream has been offloaded to the DSP).

During operation, the DSP may process an audio stream stored in DSP memory until no further data of the audio stream has been processed. In some implementations, if processing of the audio stream is not complete (e.g., the DSP retrieves further information of the audio stream, and stores it in the DSP memory allocated for the audio stream. In some implementations, the DSP stores the new audio stream data in the DSP memory allocated for that stream by overwriting the audio stream data that was already processed from DSP memory. In some implementations, the DSP retrieves the further information of the audio stream from system memory (e.g., memory 104 as shown and described with respect to FIG. 1 and/or memory 204 as shown and described with respect to FIG. 2.)

In some implementations, the DSP waits until all of the audio stream data stored in DSP memory for a stream has been processed before retrieving further data for the stream. In some cases, this has the advantage of minimizing or reducing utilization of the communications medium (e.g., communication medium 210 as shown and described with respect to FIG. 2). In some implementations, this has the advantage of minimizing or reducing a number of times that it is necessary to wake the processor to initiate further transfer of data (and potentially saving power). In some implementations, the DSP does not wait until all of the audio stream data stored in DSP memory for a stream has been processed before retrieving further data for the stream. In some cases, this has the advantage of minimizing or reducing interruption of the processing of the audio stream (e.g., due to latency in communication medium 210 as shown and described with respect to FIG. 2).

In the example of FIG. 8, FIG. 9, and Table 4, the potential power saving is greater than in the example of FIG. 3, FIG. 4, and Table 2, since all of the DSP memory allocated for stream offloading is allocated to a stream at any given time (as long as at least one stream has been offloaded), allowing a longer time between processor wakeups to refill the DSP buffer in some cases. However, the potential power saving is lesser than in the example of FIG. 5, FIG. 6, and Table 3, since some of the DSP memory allocated for stream offloading is held in reserve (i.e., not allocated to a stream) in some cases, allowing a lesser time between processor wakeups. However, this will provide for a shorter time necessary for the processor to remain awake in order to fill the buffer when a new stream is offloaded in some cases, potentially saving power in other cases.

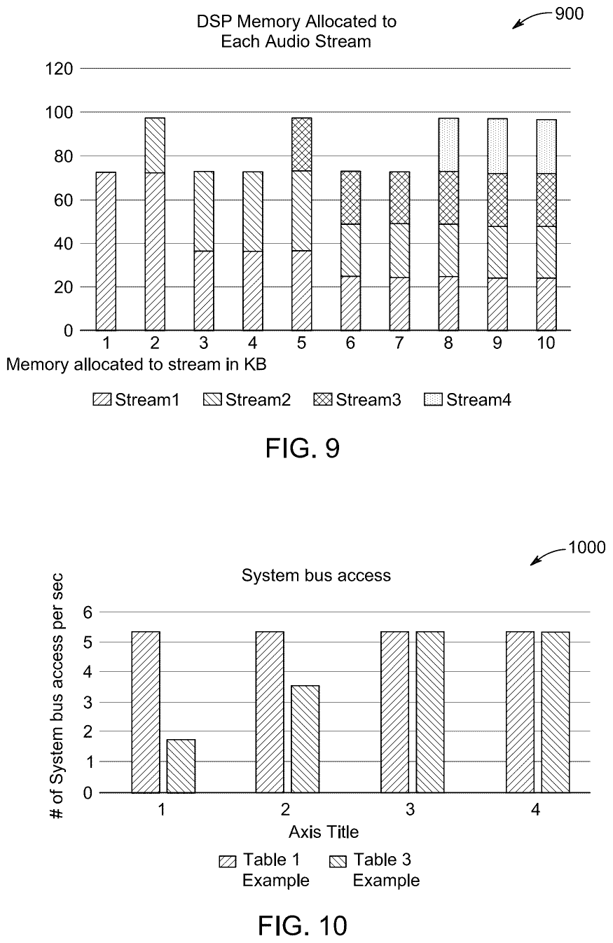

FIG. 10 is a bar graph 1000 illustrating a comparison of example system bus access per offloaded stream according to the example implementation of FIG. 8, FIG. 9, and Table 4 versus the example implementation of FIG. 5, FIG. 6, and Table 2. Table 5 lists the amount of DSP memory allocated, used, and unused, at each point in time:

TABLE 5

| | For 1 | For 2 | For 3 | For 4 |
|---|---|---|---|---|
| | Stream | Stream | Stream | Stream |
| | Offload | Offloads | Offloads | Offloads |
| Number of | 5 | 5 | 5 | 5 |
| System Bus | | | | |
| Accesses Per | | | | |
| Second using | | | | |
| the Table 1 | | | | |
| Approach | | | | |
| Number of | 2 | 4 | 5 | 5 |
| System Bus | | | | |
| Accesses Per | | | | |
| Second using | | | | |
| the Table 4 | | | | |
| Approach | | | | |

As can be seen from the graph and Table 5, system bus accesses are less frequent using the example implementation of FIG. 8, FIG. 9, and Table 4 for cases where fewer than the maximum number of stream offloads have been offloaded to the DSP. This is because each offloaded stream is allocated a larger amount of DSP memory for its offload.

Some implementations include further aspects and/or optimizations. For example, in some implementations, the host processor writes frames of the offloaded audio stream to the DSP memory as compressed audio, in cases where this would be efficient. In some implementations, the compression encoding used corresponds to a compression decoding capability of the DSP (e.g., to support other use cases, such as BlueTooth (BT), Advanced Audio Coding (AAC), and/or Subband Codec (SBC), etc. of FFT followed by run length encoding). This may have the advantage of not requiring the use of additional DSP memory to store an encoder and/or decoder. In some implementations, the host processor checks each frame to determine whether compression would save space in the DSP memory, and if so, compresses the audio. In some implementations, the host processor sets a flag in a header of the frame to indicate whether the frame is compressed, and the frame (compressed or uncompressed) is transferred to DSP memory.

In some implementations, the host processor or the DSP converts frames of the offloaded audio stream to a format that is compatible with the DSP processing. For example, in some cases, the host processor or DSP converts frames of the offloaded video stream from a higher sampling rate to a lower sampling rate (e.g., where the DSP cannot handle as high a sampling rate as the host processor, the sampling rate is reduced) before the frames of the offloaded video stream are stored in the DSP memory. In some cases, the host processor or DSP converts frames of the offloaded video stream from a higher frame rate to a lower frame rate (e.g., where the DSP cannot handle as high a frame rate as the host processor, the frame rate is reduced) before the frames of the offloaded video stream are stored in the DSP memory. In some cases, the host processor or DSP converts frames of the offloaded video stream from a higher number of channels to a lower number of channels (e.g., where the DSP cannot handle as high a number of channels as the host processor, the number of channels is reduced) before the frames of the offloaded video stream are stored in the DSP memory.

In some implementations, the amount of DSP memory allocated to each offloaded stream (or ratio, or proportion of the total amount of DSP memory allocated for all stream offloading) is based on characteristics of the offloaded stream or streams (or any other suitable basis). In some implementations, an amount, ratio, or proportion of the total amount of DSP memory allocated to a stream is based on a bit depth, sampling rate, frame rate, and/or number of channels of the stream. For example, in some implementations, if a first stream is running at 16 kilobits per second, with 2 channels and a 16 bit sampling rate, and a second stream is running at 32 kilobits per second, with 2 channels and a 16 bit sampling rate, twice as much of DSP memory is allocated to the second stream as to the first stream, since twice as much data of the second stream is processed in the same amount of time as is processed of the first stream.

In some implementations, the amount of DSP memory allocated to each stream is such that the DSP memory allocated to each stream is consumed (i.e., processed by the DSP) in the same amount of time. In some implementations, this can have the advantage of aligning the occasions when the DSP memory allocated to each stream will need to be refilled, so that that host processor only needs to awaken once to service both (or all) of the streams. This can have the advantage of reducing power consumption.

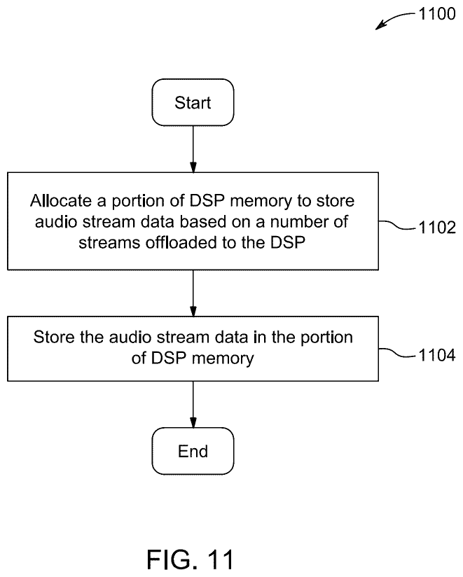

FIG. 11 is a flowchart illustrating an example method 1100 according to an example implementation. At 1102, a first portion of DSP memory is allocated to store data of a first audio stream. A size of the first portion of DSP memory is based on a number of streams offloaded to the DSP. At 1104, the data of the first audio stream is stored in the first portion. In some implementations, a portion of the DSP memory is allocated to store data of audio streams offloaded from a host processor, and the first portion of DSP memory is allocated from the portion of the DSP memory allocated to store data of audio streams offloaded from the host processor. In some implementations, the size of the first portion of DSP memory is based on a maximum number of streams offloadable to the DSP. In some implementations, the size of the first portion of DSP memory is based on a maximum number of streams offloadable to the DSP from a host processor. Some implementations include allocating a second portion of DSP memory to store data of a second audio stream; and reducing an amount of memory that is allocated to the first portion based on the number of streams offloaded to the DSP. Some implementations include allocating a second portion of DSP memory to store data of a second audio stream; and reducing an amount of memory that is allocated to the first portion based on a maximum number of streams offloadable to the DSP from a host processor. In some implementations, a size of the second portion is equal to the size of the first portion. In some implementations, a size of the second portion is based on a characteristic of the second audio stream, and the size of the first portion is based on a characteristic of the first audio stream. In some implementations, a size of the first portion gradually decreases based on the second portion. In some implementations, a portion of the DSP memory is allocated to store data of audio streams offloaded from a host processor, and a total size of DSP memory allocated to streams is less than a size of the portion of the DSP memory is allocated to store data of audio streams offloaded from the host processor.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the scheduler 136, the graphics processing pipeline 134, the compute units 132, and/or the SIMD units 138, may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for processing audio streams by a digital signal processor (DSP), the method comprising:
allocating a first portion of DSP memory to store data of a first audio stream; and
storing the data of the first audio stream in the first portion;
wherein a size of the first portion of DSP memory is based on a number of streams offloaded to the DSP.

2. The method of claim 1, wherein a portion of the DSP memory is allocated to store data of audio streams offloaded from a host processor, and the first portion of DSP memory is allocated from the portion of the DSP memory allocated to store data of audio streams offloaded from the host processor.

3. The method of claim 1, wherein the size of the first portion of DSP memory is based on a maximum number of streams offloadable to the DSP.

4. The method of claim 1, wherein the size of the first portion of DSP memory is based on a maximum number of streams offloadable to the DSP from a host processor.

5. The method of claim 1, further comprising allocating a second portion of DSP memory to store data of a second audio stream; and reducing an amount of memory that is allocated to the first portion based on the number of streams offloaded to the DSP.

6. The method of claim 1, further comprising allocating a second portion of DSP memory to store data of a second audio stream; and reducing an amount of memory that is allocated to the first portion based on a maximum number of streams offloadable to the DSP from a host processor.

7. The method of claim 5, wherein a size of the second portion is equal to the size of the first portion.

8. The method of claim 5, wherein a size of the second portion is based on a characteristic of the second audio stream, and the size of the first portion is based on a characteristic of the first audio stream.

9. The method of claim 5, wherein a size of the first portion gradually decreases based on the second portion.

10. The method of claim 1, wherein a portion of the DSP memory is allocated to store data of audio streams offloaded from a host processor, and a total size of DSP memory allocated to streams is less than a size of the portion of the DSP memory is allocated to store data of audio streams offloaded from the host processor.

11. A digital signal processor (DSP) comprising:
circuitry configured to allocate a first portion of DSP memory to store data of a first audio stream; and
circuitry configured to store the data of the first audio stream in the first portion;
wherein a size of the first portion of DSP memory is based on a number of streams offloaded to the DSP.

12. The DSP of claim 11, wherein a portion of the DSP memory is allocated to store data of audio streams offloaded from a host processor, and the first portion of DSP memory is allocated from the portion of the DSP memory allocated to store data of audio streams offloaded from the host processor.

13. The DSP of claim 11, wherein the size of the first portion of DSP memory is based on a maximum number of streams offloadable to the DSP.

14. The DSP of claim 11, wherein the size of the first portion of DSP memory is based on a maximum number of streams offloadable to the DSP from a host processor.

15. The DSP of claim 11, further comprising circuitry configured to allocate a second portion of DSP memory to store data of a second audio stream; and circuitry configured to reduce an amount of memory that is allocated to the first portion based on the number of streams offloaded to the DSP.

16. The DSP of claim 11, further comprising circuitry configured to allocate a second portion of DSP memory to store data of a second audio stream; and circuitry configured to reduce an amount of memory that is allocated to the first portion based on a maximum number of streams offloadable to the DSP from a host processor.

17. The DSP of claim 15, wherein a size of the second portion is equal to the size of the first portion.

18. The DSP of claim 15, wherein a size of the second portion is based on a characteristic of the second audio stream, and the size of the first portion is based on a characteristic of the first audio stream.

19. The DSP of claim 15, wherein a size of the first portion gradually decreases based on the second portion.

20. The DSP of claim 11, wherein a portion of the DSP memory is allocated to store data of audio streams offloaded from a host processor, and a total size of DSP memory allocated to streams is less than a size of the portion of the DSP memory is allocated to store data of audio streams offloaded from the host processor.
